(19) United States
(12) Patent Application Publication
(10) Pub. No.: US 2021/0225297 A1
(43) Pub. Date: Jul. 22, 2021

(54) BACKLIGHT MODULE AND DRIVING METHOD THEREOF, AND DISPLAY DEVICE

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Lingyun SHI, Beijing (CN); Hao ZHANG, Beijing (CN); Haiwei SUN, Beijing (CN); Ming CHEN, Beijing (CN)

(73) Assignees: BEIJING BOE OPTOELECTRONICS TECHNOLOGY CO., LTD., Beijing (CN); BOE TECHNOLOGY GROUP CO., LTD., Beijing (CN)

(21) Appl. No.: 16/306,761

(22) PCT Filed: Mar. 13, 2018
(86) PCT No.: PCT/CN2018/078840

§ 371 Date: Dec. 3, 2018

(30) Foreign Application Priority Data
Jul. 18, 2017 (CN) 201710587819.6

(51) Int. Cl. G09G 3/34; G09G 3/20

(52) U.S. Cl. CPC G09G 3/3426; G09G 2320/0646; G09G 3/2092

(57) ABSTRACT

A backlight module and a driving method thereof, and a display device are provided, and the backlight module includes a plurality of driver units and a plurality of light-emitting elements; each of the driver units is connected with one of the light-emitting element, each of the light-emitting elements is independently driven by the driver unit connected therewith; and each of the driver units is configured to control at least one of a light emission duration and a light emission brightness of the light-emitting element connected therewith.

The present application claims priority of Chinese Patent Application No. 201710587819.6 filed on Jul. 18, 2017, the disclosure of which is incorporated herein by reference in its entirety as part of the present application.

### TECHNICAL FIELD

Embodiments of the present disclosure relate to a backlight module and a driving method thereof, and a display device.

### BACKGROUND

A liquid crystal panel of a liquid crystal display device itself does not emit light; image and digital information displayed by the liquid crystal display device is formed by light, which is provided by a backlight module on a back side of the liquid crystal panel and transmits through the liquid crystal panel, and the backlight module for example is a light emitting diode (LED) backlight module. According to different arrangement modes of a light-emitting component in the backlight module, the backlight module for example is classified into a backlight module of a side-lit type and a backlight module of a direct-lit type.

### SUMMARY

At least one embodiment of the disclosure provides a backlight module, comprising: a plurality of driver units and a plurality of light-emitting elements. Each of the driver units is connected with one of the light-emitting elements, each of the light-emitting elements is independently driven by the driver unit connected therewith, and each of the driver units is configured to control at least one of a light emission duration and a light emission brightness of the light-emitting element connected therewith.

For example, the backlight module provided at least one embodiment of the disclosure further comprises: a controller unit, respectively connected with the plurality of driver units, and configured to generate and output a control signal to each of the driver units connected with the controller unit, so that each of the driver units controls at least one of the light emission duration and the light emission brightness of the light-emitting element connected therewith.

For example, the backlight module provided at least one embodiment of the disclosure further comprises: a main controller unit, connected with the controller unit and configured to output at least one of a light emission control instruction and a brightness control instruction to the controller unit, so that the controller unit generates and outputs the control signal, according to at least one of the light emission control instruction and the brightness control instruction.

For example, the backlight module provided at least one embodiment of the disclosure further comprises a chip. The controller unit and the main controller unit are integrated in the same chip.

For example, in the backlight module provided at least one embodiment of the disclosure, the plurality of driver units are arranged in M rows and N columns, where, M and N are respectively positive integers greater than or equal to 1; the controller unit includes a row driver module and a column driver module; the row driver module includes M output terminals, and an ith output terminal of the row driver module 51 is connected with N driver units in an ith row of the driver units, i=1˜M, the row driver module is configured to generate and output a first light emission control signal to the driver units row by row, and each of the driver units is configured to control the light emission duration of the light-emitting element connected therewith under an action of the first light emission control signal; and the column driver module includes N output terminals, and a jth output terminal of the column driver module is connected with a jth driver unit in each row of the driver units, j=1˜N, the column driver module is configured to generate and output a first brightness control signal to the driver units connected with the column driver module, and each of the driver units is configured to control the light emission brightness of the light-emitting element connected therewith under an action of the first brightness control signal.

For example, in the backlight module provided at least one embodiment of the disclosure, the controller unit includes a light emission duration driver module; the light emission duration driver module includes a plurality of output terminals, the plurality of output terminals of the light emission duration driver module are respectively connected with the driver units, the light emission duration driver module is configured to generate and output a second light emission control signal to each of of the driver units, and the second light emission control signal is a pulse signal; and each of the driver units is configured to control the light emission duration of the light-emitting element connected therewith under an action of the second light emission control signal.

For example, in the backlight module provided at least one embodiment of the disclosure, the controller unit further includes a light emission brightness driver module; the light emission brightness driver module includes a plurality of output terminals, the plurality of output terminals of the light emission brightness driver module are respectively connected with the driver units, and the light emission brightness driver module is configured to generate and output a second brightness control signal to the driver units connected with the light emission brightness driver module; and each of the driver units is configured to control the light emission brightness of the light-emitting element connected therewith under an action of the second brightness control signal.

For example, the backlight module provided at least one embodiment of the disclosure further comprises a control signal terminal, respectively connected with each of the light-emitting elements and the controller unit. The controller unit is further configured to output a stop light emission signal to the control signal terminal connected with the controller unit, to control the light-emitting elements connected with the control signal terminal to stop emitting light.

For example, the backlight module provided at least one embodiment of the disclosure further comprises a baseplate. The light-emitting elements are encapsulated inside the baseplate.

For example, in the backlight module provided at least one embodiment of the disclosure, the light-emitting elements are a light emitting diode.

For example, in the backlight module provided at least one embodiment of the disclosure, the light-emitting elements are a small light emitting diode or a micro light emitting diode (micro LED).

At least one embodiment of the disclosure provides a driving method of a backlight module, the backlight module comprising a plurality of driver units and a plurality of light-emitting elements. Each of the driver units is connected with one of the light-emitting elements; the driving method comprises: independently driving each of the light-emitting elements by one of the driver units, to control at least one of a light emission duration and a light emission brightness of each of the light-emitting elements.

For example, in the driving method of the backlight module provided at least one embodiment of the disclosure, the backlight module further comprises a controller unit respectively connected with the plurality of driver units and a main controller unit connected with the controller unit; the main controller unit outputs at least one of a light emission control instruction and a brightness control instruction to the controller unit; the controller unit generates and outputs a control signal to the driver units according to at least one of the light emission control instruction and the brightness control instruction, so that each of the driver units controls at least one of the light emission duration and the light emission brightness of the light-emitting element connected therewith.

For example, in the driving method of the backlight module provided at least one embodiment of the disclosure, the plurality of driver units are arranged in M rows and N columns, where, both M and N are positive integers greater than or equal to 1; the controller unit generates and outputs a first light emission control signal to the driver units row by row according to the light emission control instruction; the controller unit generates and outputs a first brightness control signal to the driver units connected with the controller unit according to the brightness control instruction; each of the driver units controls the light-emitting element connected therewith whether to emit light or not, and controls the light emission duration and the light emission brightness of the light-emitting element connected therewith under an action of the first light emission control signal and the first brightness control signal.

For example, in the driving method of the backlight module provided at least one embodiment of the disclosure, the controller unit includes a light emission duration driver module connected with all of the driver units; the light emission duration driver module generates and outputs a second light emission control signal to each of the driver units according to the light emission control instruction, wherein, the second light emission control signal is a pulse signal; each of the driver units controls the light emission duration of the light-emitting element connected therewith under an action of the second light emission control signal.

For example, in the driving method of the backlight module provided at least one embodiment of the disclosure, the controller unit includes a light emission brightness driver module connected with all of the driver units; the light emission brightness driver module generates and outputs a second brightness control signal to each of the driver units connected with the light emission brightness driver module according to the brightness control instruction; each of the driver units controls the light emission brightness of the light-emitting element connected therewith under an action of the second brightness control signal.

For example, in the driving method of the backlight module provided at least one embodiment of the disclosure, the light-emitting elements are respectively connected with the controller unit through a control signal terminal, and the driving method further comprises: outputting, by the main controller unit, a stop light emission control instruction, to the controller unit; generating and outputting, by the controller unit, a stop light emission signal to the control signal terminal connected with the controller unit according to the stop light emission control instruction; and controlling, by the control signal terminal, the light-emitting elements connected with the control signal terminal to stop emitting light under an action of the stop light emission signal.

At least one embodiment of the disclosure provides a display device, comprising the backlight module as described above.

### BRIEF DESCRIPTION OF THE DRAWINGS

In order to clearly illustrate the technical solution of at least one embodiment of the disclosure, the drawings of at least one embodiment will be briefly described in the following; it is obvious that the described drawings are only related to some embodiments of the disclosure and thus are not limitative of the disclosure.

FIG. 1 is a structural schematic diagram I of a backlight module provided by at least one embodiment of the present disclosure;

FIG. 2 is a structural schematic diagram II of the backlight module provided by at least one embodiment of the present disclosure;

FIG. 3 is a structural schematic diagram III of the backlight module provided by at least one embodiment of the present disclosure;

FIG. 4 is a structural schematic diagram IV of the backlight module provided by at least one embodiment of the present disclosure;

FIG. 5 is a structural schematic diagram V of the backlight module provided by at least one embodiment of the present disclosure;

FIG. 6A is a structural schematic diagram VI of the backlight module provided by at least one embodiment of the present disclosure;

FIG. 6B is a structural schematic diagram VII of the backlight module provided by at least one embodiment of the present disclosure;

FIG. 6C is a structural schematic diagram VIII of the backlight module provided by at least one embodiment of the present disclosure;

FIG. 7A is a schematic diagram I of relative positional relationship between a baseplate and light-emitting elements in the backlight module provided by at least one embodiment of the present disclosure;

FIG. 7B is a schematic diagram II of relative positional relationship between the baseplate and the light-emitting elements in the backlight module provided by at least one embodiment of the present disclosure;

FIG. 7C is a schematic diagram III of relative positional relationship between the baseplate and the light-emitting elements in the backlight module provided by at least one embodiment of the present disclosure;

FIG. 8 is a structural schematic diagram of a driver unit in the backlight module provided by at least one embodiment of the present disclosure;

FIG. 9 is a flow chart I of a driving method of the backlight module provided by at least one embodiment of the present disclosure;

FIG. 10 is a flow chart II of the driving method of the backlight module provided by at least one embodiment of the present disclosure;

FIG. 11A is a flow chart III of the driving method of the backlight module provided by at least one embodiment of the present disclosure;

FIG. 11B is a flow chart IV of the driving method of the backlight module provided by at least one embodiment of the present disclosure;

FIG. 11C is a flow chart V of the driving method of the backlight module provided by at least one embodiment of the present disclosure;

FIG. 12A is a flow chart VI of the driving method of the backlight module provided by at least one embodiment of the present disclosure;

FIG. 12B is a flow chart VII of the driving method of the backlight module provided by at least one embodiment of the present disclosure;

FIG. 12C is a flow chart VIII of the driving method of the backlight module provided by at least one embodiment of the present disclosure;

FIG. 12D is a flow chart IX of the driving method of the backlight module provided by at least one embodiment of the present disclosure; and

FIG. 13 is a schematic diagram of a display device provided by at least one embodiment of the present disclosure.

### REFERENCE SIGNS

1—backlight module; 2—baseplate; 201—base substrate; 202—thin film encapsulation layer; 3—driver unit; 4—light-emitting element; 5—controller unit; 6—main controller unit; 51—row driver module; 52—column driver module; 53—light emission duration driver module; 54—light emission brightness driver module; 7—backlight driver chip; 8—main driver chip; T1—first switch transistor; T2—second switch transistor; C—capacitor; LED—light emitting diode; 9—display device; 10—control signal terminal.

### DETAILED DESCRIPTION

In order to make objects, technical details and advantages of at least one embodiment of the disclosure apparent, the technical solutions of at least one embodiment will be described in a clearly and fully understandable way in connection with the drawings related to at least one embodiment of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise specified, the technical terms or scientific terms here should be of general meaning as understood by those ordinarily skilled in the art. In the specification and the claims of the present disclosure, words such as “first”, “second” and the like do not denote any order, quantity, or importance, but rather are used for distinguishing different components. Words such as “include” or “comprise” and the like denote that elements or objects appearing before the words of “include” or “comprise” cover the elements or the objects enumerated after the words of “include” or “comprise” or equivalents thereof, not exclusive of other elements or objects. Words such as “inside”, “outside”, and the like are only used for expressing relative positional relationship; if the absolute position of the described object is changed, the relative positional relationship may be correspondingly changed.

It should be noted that, the specific numbers of driver units and light-emitting elements shown in the drawings in conjunction with at least one embodiment hereinafter are merely illustrative, and do not constitute a limitation on respective actual numbers thereof.

A display device, for example, a liquid crystal display device, needs to have a backlight module; since a backlight module of a direct-lit type provides light more uniformly to a liquid crystal panel of the liquid crystal display device than a backlight module of a side-lit type, the backlight module of the direct-lit type is used more widely than the backlight module of the side-lit type. For example, in order to improve definition of a picture displayed by the liquid crystal device, it is necessary to drive the backlight module of the direct-lit type to be constantly bright on a whole light emission surface, so as to provide constant high-brightness light for the liquid crystal panel. However, in such a driving mode, the brightness is changed as a whole, and the brightness corresponding to different display regions of the liquid crystal panel cannot be differentiated. In a case where the brightness of the light provided by the backlight module of the direct-lit type is relatively high, a bright scene image may be displayed very bright, but a dark scene image may be whitened because the brightness of the light in a display region where the dark scene image needs to be displayed is still relatively high, resulting in a low contrast of the dark scene image. In addition, in a case where the backlight module of the direct-lit type continuously provides the light for the liquid crystal panel, especially in a case where the liquid crystal panel displays a picture of high-speed motion, a smear effect may be visually presented due to visual persistence of eyes, that is, a motion blur phenomenon occurs, which affects a viewing experience of a user.

At least one embodiment of the present disclosure provides a backlight module, the backlight module comprising: a plurality of driver units and a plurality of light-emitting elements; each of the driver units is connected with one of the light-emitting elements, and each of the light-emitting elements is independently driven by the driver unit connected therewith. For example, the backlight module provided by at least one embodiment is used in any display device that needs a backlight, for example, a liquid crystal display device. At least one embodiment of the present disclosure will be described with a case where the backlight module is used in the liquid crystal display device as an example.

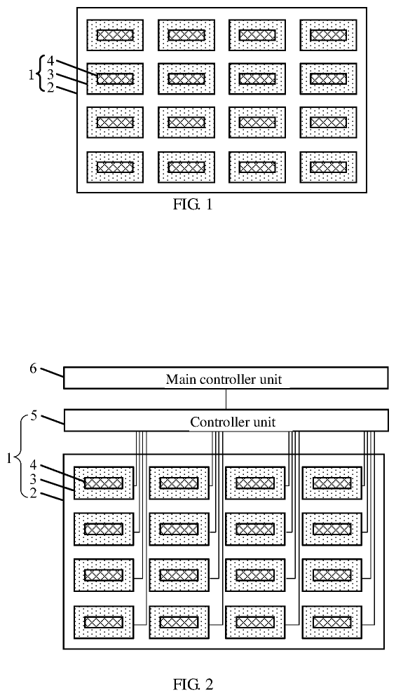

Exemplarily, FIG. 1 is a structural schematic diagram of the backlight module provided by at least one embodiment of the present disclosure. As shown in FIG. 1, the backlight module 1 is provided, and the backlight module for example is a backlight module of a direct-lit type. The backlight module 1 of the direct-lit type comprises the plurality of driver units 3 and the plurality of light-emitting elements 4. Each driver unit 3 is connected with one light-emitting element 4, and each light-emitting element 4 is independently driven by the driver unit 3 connected therewith.

For example, each of the driver units 3 is configured to control at least one of a light emission duration and a light emission brightness of the light-emitting element 4 connected therewith. For example, the driver unit 3 is electrically connected with the corresponding light-emitting element 4, and the driver unit 3 controls an operation of the corresponding light-emitting element 4 electrically connected therewith by an electrical signal.

In the backlight module 1 provided by at least one embodiment of the present disclosure, since each driver unit 3 is connected with one light-emitting element 4, each driver unit 3 independently controls the operation of the light-emitting elements 4 connected therewith. For example, each of the driver units 3 independently controls the continuous light emission duration of the light-emitting element 4 connected therewith at each time that the light-emitting element 4 emits light. For example, according to needs, each of the light-emitting elements 4 is controlled to have shorter light emission duration at each time of emitting light, so that each of the light-emitting elements 4 blinks. Thus, in a case where a picture of high-speed motion is displayed, since the light emission duration of each of the light-emitting elements is very short at each time of emitting light, a visual persistence is not generated in a human eye, and thus occurrence of a motion blur phenomenon is avoided. In addition, under the premise of ensuring a liquid crystal panel of the liquid crystal display device normally displays the picture, each of the driver units 3 independently controls the corresponding light-emitting element 4 connected therewith to blink, which reduces the light emission duration of each of the light-emitting elements at each time of emitting light, and thus reduces light emission power consumption of the backlight module 1 and saves energy.

For example, each of the driver units 3 independently controls the light emission brightness of the corresponding light-emitting element 4 connected therewith. In a case where the displayed picture includes a bright scene region and a dark scene region, regional brightness adjustment is performed by the driver units 3, so that the light-emitting element 4 in a region corresponding to the bright scene region of the picture emits light of higher brightness, and the light-emitting element 4 in a region corresponding to the dark scene region of the picture emits light of lower brightness, so as to improve layering effect of the displayed picture, further improve a static contrast and a dynamic contrast of the displayed picture, and better achieve a high-dynamic range (HDR) effect.

For example, each of the driver units 3 simultaneously controls the light emission duration and the light emission brightness of the corresponding light-emitting element 4 connected therewith, so as to simultaneously achieve the above-described technical effects.

It should be noted that, in the conventional backlight module of the direct-lit type, the driver unit is usually provided in a backlight driver chip for driving the backlight module of the direct-lit type. However, in the backlight module of the direct-lit type provided by at least one embodiment of the present disclosure, the driver unit 3 for example is extracted from the backlight driver chip to be provided on a baseplate 2. In such an arrangement mode, on the one hand, an internal structure of the backlight driver chip is simplified, which reduces design complexity of the backlight driver chip; on the other hand, the plurality of driver units 3 are provided on the baseplate 2, so that positions of the plurality of driver units 3 are in one-to-one correspondence with positions of the plurality of light-emitting elements 4, which makes control of the light-emitting elements 4 by the driver units 3 more intuitive and direct.

For example, the driver unit 3 is implemented by hardware or a combination of hardware and software. For example, the driver unit 3 is a drive circuit.

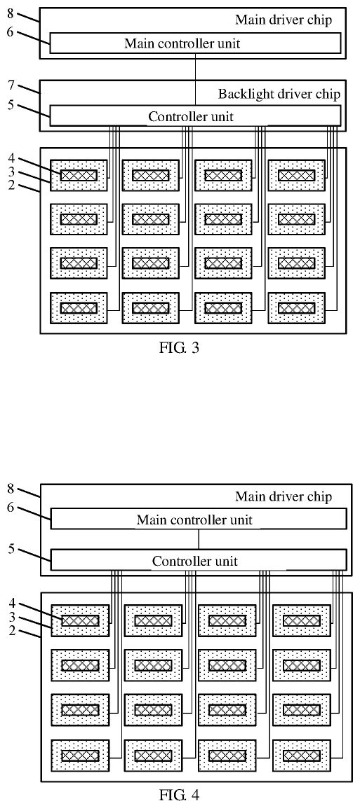

FIG. 2 is a structural schematic Diagram II of the backlight module provided by at least one embodiment of the present disclosure; FIG. 3 is a structural schematic Diagram III of the backlight module provided by at least one embodiment of the present disclosure; and FIG. 4 is a structural schematic Diagram IV of the backlight module provided by at least one embodiment of the present disclosure.

As shown in FIG. 2, the backlight module 1 further comprises a controller unit 5. The controller unit 5 is respectively connected with the plurality of driver units 3. The controller unit 5 is configured to generate and output a control signal to each of the driver units 3 connected with the controller unit 5, so that each of the driver units 3 controls at least one of the light emission duration and the light emission brightness of the light-emitting element 4 connected therewith. That is, the control signal generated and output by the controller unit 5 to the driver unit 3 connected with the controller unit 5 is used for causing the driver unit 3 to control the light emission duration of the light-emitting element 4 connected with the driver unit 3, or is used for causing the driver unit 3 to control the light emission brightness of the light-emitting element 4 connected with driver unit 3, or is used for causing the driver unit 3 to simultaneously control the light emission duration and the light emission brightness of the light-emitting element 4 connected with the driver unit 3. For example, in at least one embodiment of the present disclosure, the controller unit 5 is configured in a variety of modes. For example, the controller unit 5 is in signal connection with the driver unit 3, further for example, the controller unit 5 is electrically connected with the driver unit 3 in a wired manner. For example, the controller unit 5 includes a control circuit that controls the driver unit 3 to implement the above-described operation by an electrical signal. A type and configuration of the controller unit will not be limited in the embodiments of the present disclosure, and those skilled in the art may reasonably design according to the requirements of specific products.

For example, the controller unit 5 is implemented by hardware or a combination of hardware and software. For example, the controller unit 5 is the control circuit.

For example, the backlight module 1 further comprises a main controller unit 6. The main controller unit 6 is connected with the controller unit 5 and configured to output at least one of a light emission control instruction and a brightness control instruction to the controller unit 5, so that the controller unit 5, according to at least one of the light emission control instruction and the brightness control instruction, generates and outputs the control signal to each of the driver units 3 connected with the controller unit 5. For example, the main controller unit 6 is in signal connection with the controller unit 5, further for example, the main controller unit 6 is electrically connected with the controller unit 5 in a wired manner. For example, the main controller unit 6 is a digital signal processor (DSP), a programmable logic controller (PLC) and the like; alternatively, the main controller unit 6 is a general-purpose computer device, for example, a central processing unit (CPU), and the like; alternatively, the main controller unit 6 is controlled by a program to implement the above-described controlling operation of the driver unit 3. For example, the main controller unit 6 is provided in a main driver chip of the liquid crystal display device, so that it is not necessary to additionally provide a chip for arranging the main controller unit, which is favorable for simplifying the structure of the backlight module, so that in a case where the backlight module provided by at least one embodiment of the present disclosure is used in the liquid crystal display device, it is favorable for simplifying a structure of the liquid crystal display device.

The backlight module provided by at least one embodiment of the present disclosure further comprises a chip. For example, as shown in FIG. 3, in the backlight module 1 provided by at least one embodiment of the present disclosure, the controller unit 5 and the main controller unit 6 are provided in different chips. For example, the controller unit 5 is provided in the backlight driver chip 7, and the main controller unit 6 is provided in the main driver chip 8. In such an arrangement mode, in a case where it is necessary to drive the light-emitting element 4 to emit light, the main controller unit 6 of the main driver chip 8 outputs the control instruction to the controller unit 5 of the backlight driver chip 7, and after receiving the control instruction, the controller unit 5 controls at least one of the light emission duration and the light emission brightness of the light-emitting element 4 connected with the driver unit 3 through the driver unit 3. In such an arrangement mode, the light-emitting element 4 is driven to emit light by a combined action of the main driver chip 8 and the backlight driver chip 7.

For example, as shown in FIG. 4, the controller unit 5 and the main controller unit 6 is integrated in the same chip. For example, the controller unit 5 is integrated into the main driver chip 8. The driver units 3 have been provided on the baseplate 2; after the controller unit 5 is further extracted from the backlight driver chip 7 and integrated in the main driver chip 8, it is no longer necessary to independently provide the backlight driver chip in the liquid crystal display device. Therefore, in such an arrangement mode, it is only necessary to provide the control signal to the driver unit 3 by adopting the main driver chip 8 so as to implement control of the light emission duration and the light emission brightness of the light-emitting element 4, which not only simplifies a control flow, but also makes a control process more convenient, and further reduces the fabrication costs.

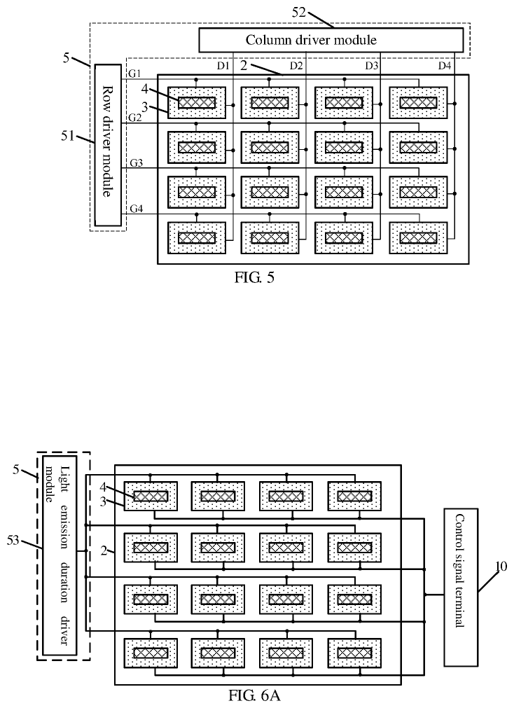

FIG. 5 is a structural schematic Diagram V of the backlight module provided by at least one embodiment of the present disclosure. As shown in FIG. 5, the plurality of driver units 3 are arranged in M rows and N columns, where, M and N are respectively positive integers greater than or equal to 1. For example, the controller unit 5 includes a row driver module 51 and a column driver module 52. The row driver module 51 includes M output terminals corresponding to the number of rows of the driver units 3, and an ith output terminal of the row driver module 51 is connected with N driver units 3 in an ith row of the driver units 3, i=1˜M. The row driver module 51 is configured to generate and output a first light emission control signal to the driver units 3 row by row. Each of the driver units 3 controls the light emission duration of the corresponding light-emitting element 4 connected therewith under an action of the first light emission control signal. The column driver module 52 includes N output terminals corresponding to the number of columns of the driver units 3, and a j th output terminal of the column driver module 52 is connected with a j th driver unit 3 in each row of the driver units 3, j=1˜N. The column driver module 52 is configured to generate and output a first brightness control signal to the driver units 3 connected with the column driver module 52. Each of the driver units 3 controls the light emission brightness of the corresponding light-emitting element 4 connected therewith under an action of the first brightness control signal.

For example, the row driver module 51 is a Gate Driver on Array (GOA) circuit, and the column driver module 52 is a data circuit.

Exemplarily, with a case where M=4 and N=4 as an example, in a first period of a light emission cycle, the row driver module 51 outputs the first light emission control signal to 4 driver units 3 of a 1st row through a gate line G1; the column driver module 52 outputs the first brightness control signal to the driver units 3 of a 1st column to a 4th column through data lines D1 to D4. During the first period of the light emission cycle, the driver units 3 of the 1st row drive the light-emitting elements 4 of the 1st row to emit light, under a combined action of the first light emission control signal and the first brightness control signal; and the light emission brightness of the light-emitting elements 4 of the 1st row is respectively determined by the first brightness control signal transmitted by the data line corresponding thereto. At this time, the light-emitting elements 4 of a 2nd row to a fourth row do not emit light.

In a second period of the light emission cycle, the row driver module 51 outputs the first light emission control signal to 4 driver units 3 of a 2nd row through a gate line G2, and the column driver module 52 outputs the first brightness control signal to the driver units 3 of the 1st column to the 4th column through the data lines D1 to D4. During the second period of the light emission cycle, the driver units 3 of the 2nd row drive the light-emitting elements 4 of the 2nd row to emit light under the combined action of the first light emission control signal and the first brightness control signal, and the light emission brightness of the light-emitting elements 4 of the 2nd row is respectively determined by the first brightness control signal transmitted by the data line corresponding thereto. At this time, the light-emitting elements 4 of the 1st row, a 3rd row, and a 4th row do not emit light.

So on and so forth, until the end of the light emission of the light-emitting elements 4 of the 4th row.

Within the light emission cycle, the light-emitting elements 4 emit light row by row, so that each of the light-emitting elements 4 emit light only once in the light emission cycle, that is, each of the light-emitting elements 4 is controlled to blink. Thus, in the case where the picture of high-speed motion is displayed, since the continuous light emission duration of each of the light-emitting elements 4 is very short, the visual persistence is not generated in the human eye, and thus the occurrence of the motion blur phenomenon is avoided. In addition, since the light emission brightness of each of the light-emitting elements 4 is independently controlled by the first brightness control signal transmitted by the corresponding data line, the column driver module 52 outputs the first brightness control signal with different values to the driver units 3 of different regions, so that the light-emitting element 4 in the region corresponding to the bright scene region of the picture emits the light of higher brightness and the light-emitting element 4 in the region corresponding to the dark scene region of the picture is controlled to emit the light of lower brightness, so as to improve contrast of the picture.

It should be noted that, in such a driving mode, each of the driver units 3 controls the light emission duration and the light emission brightness of the corresponding light-emitting element 4, under the combined action of the first light emission control signal and the first brightness control signal. For example, in a case where the row driver module 51 provides the first light emission control signal row by row, the column driver module 52 controls the light-emitting elements 4 in a partial region to emit light by outputting the first brightness control signal to the driver units 3 corresponding to the partial region, the light-emitting elements 4 in other region than the partial region do not emit light, and thus a partial display function is achieved.

With the driver units 3 and the light-emitting elements 4 of the 1st row as an example, in a case where the row driver module 51 outputs the first light emission control signal to the driver units 3 of the 1st row through the gate line G1, the column driver module 52 for example only outputs the first brightness control signal of a certain value to the driver units 3 of the 1st column and the 2nd column through the data line D1 and the data line D2, so as to control the light-emitting element 4 of the 1st row and the 1st column and the light-emitting element 4 of the 1st row and the 2nd column to emit light, and control the light-emitting element 4 of the 1st row and the 3rd column and the light-emitting element 4 of the 1st row and the 4th column not to emit light, to implement the partial display.

The above-described embodiments are described with the case where controls of the light emission duration and the light emission brightness of the light-emitting element are implemented simultaneously as an example. In another embodiments of the present disclosure, one of light emission duration of the light-emitting element and the light emission brightness of the light-emitting element is controlled.

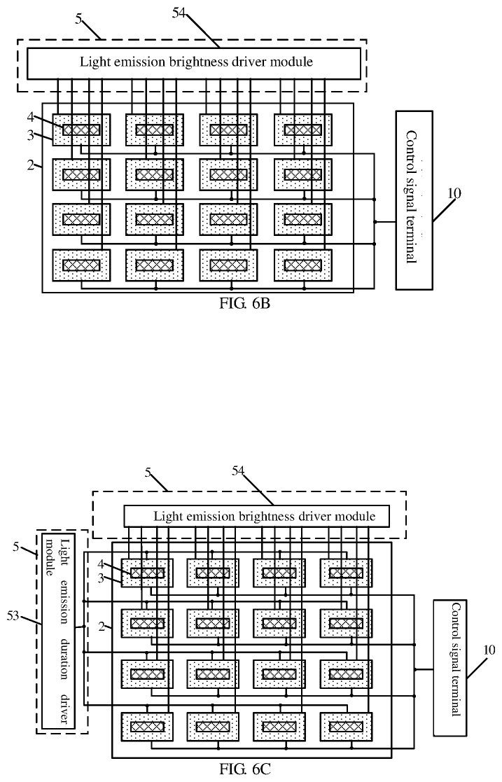

FIG. 6A is a structural schematic Diagram VI of the backlight module provided by at least one embodiment of the present disclosure, FIG. 6B is a structural schematic Diagram VII of the backlight module provided by at least one embodiment of the present disclosure, and FIG. 6C is a structural schematic Diagram VIII of the backlight module provided by at least one embodiment of the present disclosure. In at least one embodiment shown in FIG. 6A, the controller unit 5 for example includes a light emission duration driver module 53.

The light emission duration driver module 53 includes a plurality of output terminals, and the plurality of output terminals of the light emission duration driver module 53 are respectively connected with all of the driver units 3. The light emission duration driver module 53 is configured to generate and output a second light emission control signal to at least a portion of the driver units 3, and the second light emission control signal is a pulse signal. Each of the driver units 3 is configured to control the light emission duration of the corresponding light-emitting element 4 connected therewith under an action of the second light emission control signal.

For example, in at least one embodiment shown in FIG. 6B, the controller unit 5 includes a light emission brightness driver module 54. The light emission brightness driver module 54 includes a plurality of output terminals, and the plurality of output terminals of the light emission brightness driver module 54 are respectively connected with the plurality of driver units 3 in a one-to-one manner. The light emission brightness driver module 54 is configured to generate and output a second brightness control signal to the driver units 3 connected with the light emission brightness driver module 54. Each of the driver unit 3 is further configured to control the light emission brightness of the corresponding light-emitting element 4 connected therewith under an action of the second brightness control signal.

In at least one embodiment shown in FIG. 6C, the controller unit 5 includes the light emission duration driver module 53 and the light emission brightness driver module 54. The light emission duration driver module 53 and the light emission brightness driver module 54 are respectively the same as those shown in FIG. 6A and FIG. 6B, details thereof for example refer to the above description. The light emission duration driver module 53 and the light emission brightness driver module 54 respectively control the light emission duration and the light emission brightness of each of the light-emitting elements 4 through the driver units 3.

At least one embodiment shown in FIG. 6C is different from at least one embodiment shown in FIG. 5 in the driving principle; in at least one embodiment shown in FIG. 6C, some or all light-emitting elements 4 on the baseplate 2 are controlled to emit light only by the second light emission control signal output by the light emission duration driver module 53. Further, since the second light emission control signal output by the light emission duration driver module 53 is the pulse signal, the second light emission control signal has a certain duty ratio; by setting the duty ratio of the second light emission control signal, the light emission duration of the light-emitting elements 4 are controlled so that each of the light-emitting elements 4 blinks. Therefore, in the case where the picture of high-speed motion is displayed, since the continuous light emission duration of each of the light-emitting elements 4 is short, the visual persistence is not generated in the human eye, and thus the occurrence of the motion blur phenomenon is avoided.

In addition, since each of the driver units 3 is connected with one output terminal of the light emission brightness driver module 54, the light emission brightness driver module 54 for example outputs the second brightness control signal with different values to the driver units 3 through different output terminals to implement independent control of the light emission brightness of each of the light-emitting element 4, so that the light-emitting element 4 in the region corresponding to the bright scene region of the picture emits the light of higher brightness and the light-emitting element 4 in the region corresponding to the dark scene region of the picture emits the light of lower brightness, so as to improve the contrast of the picture. Therefore, in at least one embodiment shown in FIG. 6, only the light emission duration of each of the light-emitting elements is controlled, or the light emission brightness of each of the light-emitting elements is controlled while controlling the light emission duration, which may be selected according to needs.

For example, the light emission duration driver module 53 is implemented by hardware or a combination of hardware and software. For example, the light emission duration driver module 53 is a light emission duration drive circuit.

For example, the light emission brightness driver module 54 is implemented by hardware or a combination of hardware and software. For example, the light emission brightness driver module 54 is a light emission brightness drive circuit.

For example, the backlight module shown in FIG. 6A to FIG. 6C further comprises a control signal terminal 10, and the control signal terminal 10 is respectively connected with each of the light-emitting elements 4 and the controller unit 5. The controller unit 5 is configured to receive a stop light emission control instruction output by the main controller unit 6, and then generate and provide a stop light emission signal to the control signal terminal 10 connected with the controller unit to control the light-emitting element 4 connected with the control signal terminal to stop emitting light. In this way, in a case where it is necessary to implement partial display function, the controller unit 5 for example provides the stop light emission signal to the light-emitting element 4 corresponding to a partial region where it is not necessary to display the picture, through the control signal terminal 10 connected therewith, so as to control the light-emitting element 4 corresponding to the partial region to stop emitting light, and thus implement partial display of the picture.

For example, the control signal terminal 10 is implemented by hardware or a combination of hardware and software. For example, the control signal terminal 10 is a stop light emission drive circuit.

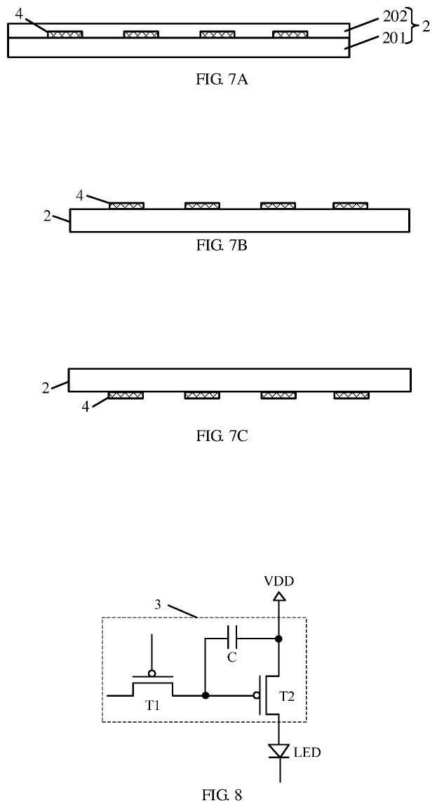

For example, the backlight module 1 further comprises the baseplate 2. As shown in FIG. 7A, the light-emitting elements 4 for example are encapsulated inside the baseplate 2. In a case where the light-emitting elements 4 are encapsulated inside the baseplate 2, the baseplate 2 includes a base substrate 201 and a thin film encapsulation layer 202, and the thin film encapsulation layer 202 covers the light-emitting elements 4 to seal the light-emitting elements 4. The thin film encapsulation layer 202 is relatively light and thin, which implements sealing of the light-emitting elements 4 to be favorable for improving service life of the light-emitting elements 4, and at a same time, facilitate lightening and thinning of the backlight module, to further reduce a quality and a thickness of the display device (for example, the liquid crystal display device) having the backlight module provided by at least one embodiment of the present disclosure. For example, the thin film encapsulation layer 202 is an organic thin film encapsulation layer, which is made of, for example, resin materials or resin materials added with functional particles that block moisture, oxygen, and the like; or the thin film encapsulation layer 202 is an inorganic thin film encapsulation layer, which is made of, for example, silicon nitride or silicon oxide, and the like; alternatively, the thin film encapsulation layer 202 includes an inorganic thin film encapsulation layer and an organic thin film encapsulation layer which are stacked. Of course, the material of the thin film encapsulation layer 202 is not limited to the types listed above.

For example, the base substrate 201 according to at least one embodiment is transparent or opaque. For example, the base substrate 201 is made of an inorganic material, for example, glass or quartz, and the like; or is made of an organic material, for example, polyethylene, polypropylene, and the like.

For example, as shown in FIG. 7B or FIG. 7C, the light-emitting elements 4 are provided on a surface of the baseplate 2, the surface faces the display panel, and at this time, the baseplate 2 is, for example, a glass substrate or a quartz substrate, and the like. For example, the plurality of driver units 3 are provided inside the baseplate 2, or are provided on the surface of the baseplate 2. Actually, it is only necessary to ensure that the light-emitting element 4 is connected with the corresponding driver unit 3, and the position of the driver unit 3 may be designed according to needs. Positions for providing the light-emitting element and the driver unit are not limited in at least one embodiment of the present disclosure.

For example, the light-emitting elements 4 are a light emitting diode. For example, the light-emitting elements 4 are a small light emitting diode or a micro light emitting diode (Micro LED).

For example, in a case where the light-emitting element 4 is the light emitting diode, an internal circuit structure of each of the driver units 3 for example is a 2T1C structure. As shown in FIG. 8, the driver unit 3 for example includes a first switch transistor T1, a second switch transistor T2, and a capacitor C; a second electrode of the first switch transistor T1, a control electrode of the second switch transistor T2 and a first electrode plate of the capacitor C are connected with each other, a second electrode plate of the capacitor C and a first electrode of the second switch transistor T2 are respectively connected with a power terminal VDD, and a second electrode of the second switch transistor T2 is connected with an anode of the light emitting diode.

In at least one embodiment shown in FIG. 5, in a case where the controller unit 5 includes the row driver module 51 and the column driver module 52, a control electrode of the first switch transistor T1 is connected with the corresponding output terminal of the row driver module 51 through the gate line, a first electrode of the first switch transistor T1 is connected with the corresponding output terminal of the column driver module 52 through the data line, and a cathode of the light emitting diode is connected with the ground. In at least one embodiment shown in FIG. 6, in a case where the controller unit 5 includes the light emission duration driver module 53 and the light emission brightness driver module 54, the control electrode of the first switch transistor T1 is connected with the corresponding output terminal of the light emission duration driver module 53, the first electrode of the first switch transistor T1 is connected with the corresponding output terminal of the column driver module 52, and the cathode of the light emitting diode LED is connected with the control signal terminal. A working principle of the driver unit 3 is the same as that of the driver unit of the 2T1C structure, which will not be repeated herein. Of course, the internal structure of the driver unit 3 according to at least one embodiment may be other circuit structures, which is not be specifically limited in the embodiments of the present disclosure.

It should be noted that, in both of the driving modes as described above, each of the light-emitting elements 4 for example is controlled to have shorter light emission duration at each time of emitting light, and thus the backlight module 1 of the direct-lit type provided by at least one embodiment of the present disclosure is applicable to a backlight unit modulation product with shorter display time (that is, in which the displayed picture changes faster), for example, a virtual reality (VR) product and an augmented reality (AR) product.

At least one embodiment of the present disclosure further provides a driving method of a backlight module, and the driving method of the backlight module is used for driving any one of the backlight modules provided by at least one embodiment of the present disclosure.

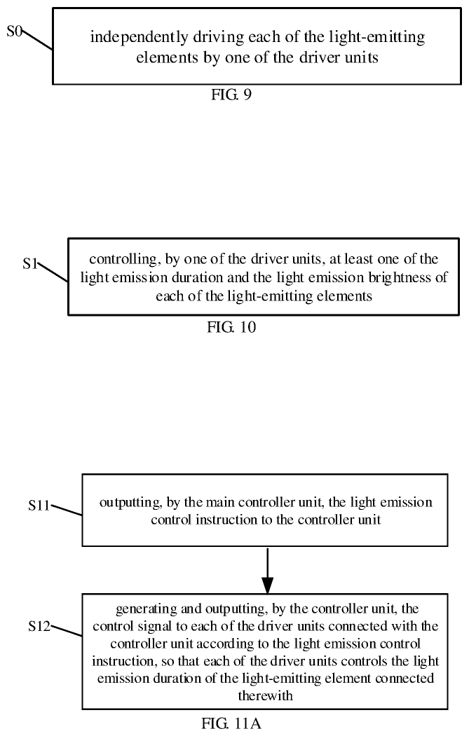

As shown in FIG. 9, the driving method of the backlight module provided by at least one embodiment for example comprises: step S0: independently driving each of the light-emitting elements by one of the driver units.

As shown in FIG. 10, in the driving method of the backlight module provided by at least one embodiment, step S0 in FIG. 9 for example include step S1: controlling, by one of the driver units, at least one of the light emission duration and the light emission brightness of each of the light-emitting elements.

For example, in the backlight module, the controller unit 5 is connected with the main controller unit 6. For example, the main controller unit 6 is the main controller unit of the liquid crystal display device in which the backlight module is provided.

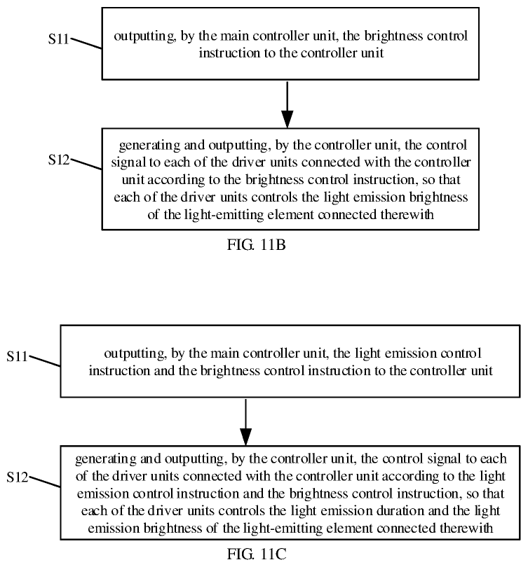

For example, the light emission duration of the light emitting element connected with the driver unit is independently controlled by the driver unit. For example, with respect to the backlight module shown in FIG. 6A, as shown in FIG. 11A, step S1 in FIG. 10 for example includes:

Step S11: outputting, by the main controller unit, the light emission control instruction to the controller unit.

Step S12: generating and outputting, by the controller unit, the control signal to each of the driver units connected with the controller unit according to the light emission control instruction, so that each of the driver units controls the light emission duration of the light-emitting element connected therewith.

In this way, since each of the driver units independently controls the light emission duration of the light-emitting element connected therewith at each time of emitting light, each of the driver units for example is instructed to control the light-emitting element connected therewith to blink, that is, each of the light-emitting elements is controlled to have shorter light emission duration at each time of emitting light. Thus, in the case where the picture of high-speed motion is displayed, since the light emission duration for each of the light-emitting element is very short, the visual persistence picture is not generated in the human eye, and thus the occurrence of the motion blur phenomenon is avoided.

For example, the light emission brightness of the light emitting element connected with the driver unit is independently controlled by the driver unit. For example, with respect to the backlight module shown in FIG. 6B, as shown in FIG. 11B, step S1 in FIG. 10 for example includes:

Step S11: outputting, by the main controller unit, the brightness control instruction to the controller unit.

Step S12: generating and outputting, by the controller unit, the control signal to each of the driver units connected with the controller unit according to the brightness control instruction, so that each of the driver units controls the light emission brightness of the light-emitting element connected therewith.

Since each of the driver units independently controls the light emission brightness of the light-emitting element connected therewith, regional brightness adjustment is performed by the driver units in a case where the displayed picture includes the bright scene region and the dark scene region, so that the light-emitting element in the region corresponding to the bright scene region of the picture emits light of higher brightness and the light-emitting element in the region corresponding to the dark scene region of the picture emits light of lower brightness, so as to improve contrast of the picture.

For example, the light emission duration and the light emission brightness of the light-emitting element connected with the driver unit are both controlled by the driver unit simultaneously. With respect to the backlight module shown in FIG. 6C, as shown in FIG. 11C, step S1 in FIG. 10 for example includes:

Step S11: outputting, by the main controller unit, the light emission control instruction and the brightness control instruction to the controller unit, according to brightness degrees of different regions of the picture to be displayed.

Step S12: generating and outputting, by the controller unit, the control signal to each of the driver units connected with the controller unit according to the light emission control instruction and the brightness control instruction, so that each of the driver units controls the light emission duration and the light emission brightness of the light-emitting element connected therewith.

In this way, simultaneous control of the light emission duration and the light emission brightness of the light-emitting element connected with the driver unit is implemented, so as to simultaneously achieve the effects of avoiding the occurrence of the motion blur phenomenon and improving the contrast of the picture.

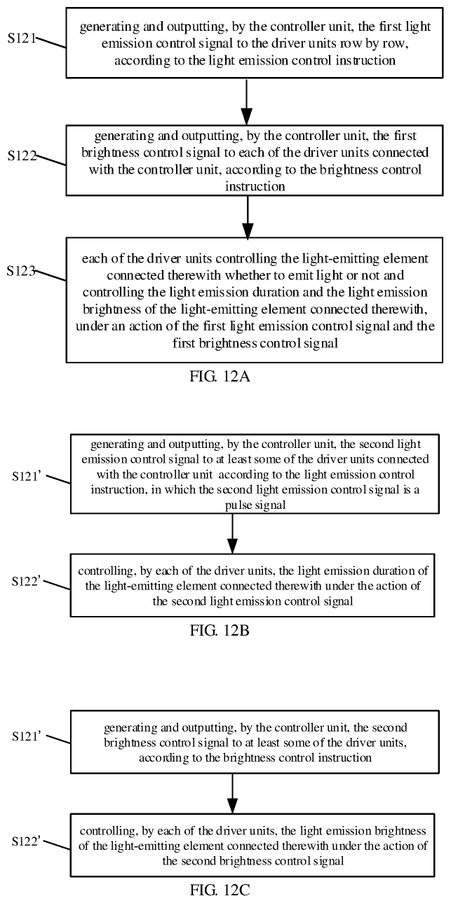

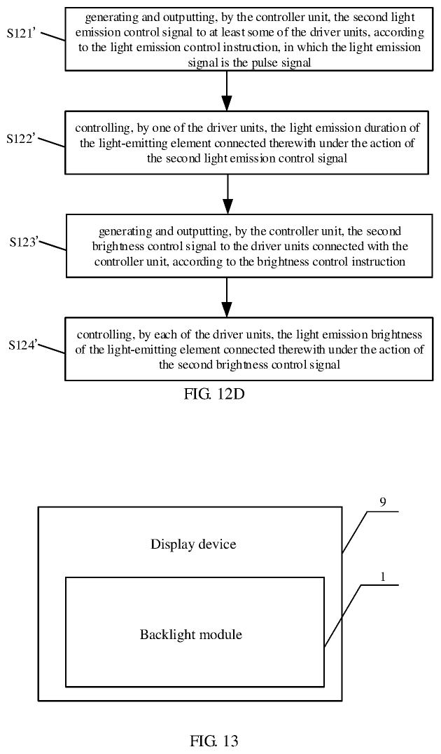

For example, with respect to the backlight module shown in FIG. 5, the plurality of driver units are arranged in M rows and N columns, where, M and N are both positive integers greater than or equal to 1. As shown in FIG. 12A, step S12 in FIG. 11C for example includes:

Step S121: generating and outputting, by the controller unit, the first light emission control signal to the driver units row by row, according to the light emission control instruction.

Step S122: generating and outputting, by the controller unit, the first brightness control signal to each of the driver units connected with the controller unit, according to the brightness control instruction.

Step S123: each of the driver units controlling the light-emitting element connected therewith whether to emit light or not and controlling the light emission duration and the light emission brightness of the light-emitting element connected therewith, under an action of the first light emission control signal and the first brightness control signal.

In the mode of driving row by row, each of the light-emitting elements emit light once in the light emission cycle, that is, each of the light-emitting elements is controlled to blink. In this way, in the case where the picture of high-speed motion is displayed, for example, in the case where the backlight module is used in the VR or the AR or other display apparatus, the visual persistence is not generated in the human eye, and thus the occurrence of the motion blur phenomenon is avoided. Moreover, since the light emission brightness of each of the light-emitting elements is independently controlled by the corresponding first brightness control signal, the light-emitting elements of different positions for example are controlled to have different light emission brightness while the independent control of the light emission duration of each of the light-emitting elements is implemented, so as to improve the contrast of the picture.

In addition, in such driving mode, in a case where the first light emission control signal is provided row by row, the first brightness control signal for example is provided only to the driver units in a partial region, and thus, the light-emitting elements corresponding to the partial region are controlled to emit light, and the light-emitting elements corresponding to other region than the partial region do not emit light, so as to implement the partial display function.

It should be noted that, an order of the above-described steps S121 and S122 is merely an illustrative description, and does not represent a limitation of the order in which the controller unit outputs the first light emission control signal and outputs the first brightness control signal. For example, the controller unit firstly outputs the first light emission control signal, and then outputs the first brightness control signal, or the controller unit simultaneously emits the first light emission control signal and the first brightness control signal, which are not limited in the embodiments of the disclosure.

For example, with respect to the backlight module shown in FIG. 6A, the controller unit includes the light emission duration driver module connected with all of the driver units. As shown in FIG. 12B, step S12 in FIG. 11A for example includes:

Step S121′: generating and outputting, by the controller unit, the second light emission control signal to at least some of the driver units connected with the controller unit according to the light emission control instruction, in which the second light emission control signal is a pulse signal.

Step S122′: controlling, by each of the driver units, the light emission duration of the light-emitting element connected therewith under the action of the second light emission control signal.

For example, in the above-described step S121′, the light emission duration driver module of the controller unit generates and outputs the second light emission control signal to at least some of the driver units.

In such a driving mode, all of the light-emitting elements for example are controlled to emit light simultaneously by the second light emission control signal; however, since the second light emission control signal is the pulse signal, the light emission duration of all of the light-emitting elements for example are controlled according to a duty ratio of the second light emission control signal, so that each of the light-emitting elements is controlled to blink. Thus, in a case where the picture of high-speed motion is displayed, the continuous light emission duration of each of the light-emitting elements is very short, and thus the visual persistence is not generated in the human eye, and the occurrence of the motion blur phenomenon is avoided.

For example, with respect to the driver module shown in FIG. 6B, as shown in FIG. 12C, step S12 in FIG. 11B for example includes:

Step S121′: generating and outputting, by the controller unit, the second brightness control signal to at least some of the driver units, according to the brightness control instruction.

Step S122′: controlling, by each of the driver units, the light emission brightness of the light-emitting element connected therewith under the action of the second brightness control signal.

For example, in step S121′ shown in FIG. 12C, the light emission brightness driver module of the controller unit generates and outputs the second brightness control signal to some or all of the driver units according to the brightness control instruction.

In such a driving mode, the light emission brightness of each of the light-emitting elements is independently controlled by the second brightness control signal received by one of the driver units, so that the light-emitting elements at different positions for example are controlled to have different light emission brightness, so as to improve the contrast of the displayed picture.

According to at least one embodiment shown in FIG. 6C, as shown in FIG. 12D, step S12 in FIG. 11C for example includes:

Step S121′: generating and outputting, by the controller unit, the second light emission control signal to at least some of the driver units, according to the light emission control instruction, in which the light emission signal is the pulse signal.

Step S122′: controlling, by one of the driver units, the light emission duration of the light-emitting element connected therewith under the action of the second light emission control signal.

Step S123′: generating and outputting, by the controller unit, the second brightness control signal to the driver units connected with the controller unit, according to the brightness control instruction.

Step S124′: controlling, by each of the driver units, the light emission brightness of the light-emitting element connected therewith under the action of the second brightness control signal.

In such a driving mode, all of the light-emitting elements are controlled to emit light simultaneously by the second light emission control signal; however, since the second light emission control signal is the pulse signal, the light emission duration of all of the light-emitting elements for example are controlled according to the duty ratio of the second light emission control signal, so that each of the light-emitting elements blinks. Thus, in a case where the picture of high-speed motion is displayed, since the continuous light emission duration of each of the light-emitting elements is very short, the visual persistence is not generated in the human eye, and thus the occurrence of the motion blur phenomenon is avoided. The driving method shown in FIG. 12D is able to implement control of the light emission duration of each of the light-emitting elements, and at a same time, implement control of the light emission brightness of each of the light-emitting elements, and the light emission brightness of each of the light-emitting elements is independently controlled by the received second brightness control signal, so that the light-emitting elements at different positions for example are controlled to have different light emission brightness, so as to improve the contrast of the displayed picture.

In addition, as shown in FIG. 6A to FIG. 6C, the light-emitting elements are respectively connected with the controller unit through the control signal terminal, in this case, the driving method of the backlight module for example further comprises: outputting, by the main controller unit, the stop light emission control instruction; generating and outputting, by the controller unit, the stop light emission signal to the control signal terminal connected with the controller unit according to the stop light emission control instruction; controlling, by the control signal terminal, each of the light-emitting elements connected with the control signal terminal to stop emitting light under the action of the stop light emission signal.

In a case where it is necessary to display the picture partially, the controller unit for example provides the stop light emission signal to the light-emitting elements corresponding to the partial region where it is not necessary to display the picture by the control signal terminal connected with the light-emitting elements, so as to control the light-emitting elements corresponding to the partial region to stop emitting light.

It should be noted that, in the driving method of the backlight module provided by at least one embodiment of the present disclosure, description in at least one embodiment of the backlight modules may be referred to for specific types of the main controller unit, the controller unit, the driver unit and the control signal terminal.

At least one embodiment of the present disclosure further provides a display device, and the display device comprises any one of the backlight modules provided by at least one embodiment of the present disclosure.

Exemplarily, FIG. 13 is a schematic diagram of the display device provided by at least one embodiment of the present disclosure. As shown in FIG. 13, the display device 9 comprises any one of the backlight modules 1 provided by at least one embodiment of the present disclosure. For example, the display device is any display device that needs a backlight, for example, the liquid crystal display device. The display device provided by at least one embodiment comprises any one of the backlight modules 1 provided by at least one embodiment of the present disclosure, and therefore, the occurrence of the motion blur phenomenon is avoided in the display device provided by at least one embodiment. In addition, the contrast of the displayed picture is improved, and thus the display performance of the liquid crystal display device is further improved.

The foregoing embodiments merely are exemplary embodiments of the disclosure, and not intended to define the scope of the disclosure, and the scope of the disclosure is determined by the appended claims.

1. A backlight module, comprising:
a plurality of driver units and a plurality of light-emitting elements;
wherein, each of the driver units is connected with one of the light-emitting elements, each of the light-emitting elements is independently driven by the driver unit connected therewith, and each of the driver units is configured to control at least one of a light emission duration and a light emission brightness of the light-emitting element connected therewith.

2. The backlight module according to claim 1, further comprising:
a controller unit, respectively connected with the plurality of driver units, and configured to generate and output a control signal to each of the driver units connected with the controller unit, so that each of the driver units controls at least one of the light emission duration and the light emission brightness of the light-emitting element connected therewith.

3. The backlight module according to claim 2, further comprising:
a main controller unit, connected with the controller unit and configured to output at least one of a light emission control instruction and a brightness control instruction to the controller unit, so that the controller unit generates and outputs the control signal, according to at least one of the light emission control instruction and the brightness control instruction.

4. The backlight module according to claim 3, further comprising a chip, wherein, the controller unit and the main controller unit are integrated in the same chip.

5. The backlight module according to claim 2, wherein,
the plurality of driver units are arranged in M rows and N columns, where, M and N are respectively positive integers greater than or equal to 1;
the controller unit includes a row driver module and a column driver module;
the row driver module includes M output terminals, and an ith output terminal of the row driver module is connected with N driver units in an ith row of the driver units, i=1˜M, the row driver module is configured to generate and output a first light emission control signal to the driver units row by row, and each of the driver units is configured to control the light emission duration of the light-emitting element connected therewith under an action of the first light emission control signal; and
the column driver module includes N output terminals, and a jth output terminal of the column driver module is connected with a jth driver unit in each row of the driver units, j=1˜N, the column driver module is configured to generate and output a first brightness control signal to the driver units connected with the column driver module, and each of the driver units is configured to control the light emission brightness of the light-emitting element connected therewith under an action of the first brightness control signal.

6. The backlight module according to claim 2, wherein,
the controller unit includes a light emission duration driver module;
the light emission duration driver module includes a plurality of output terminals, the plurality of output terminals of the light emission duration driver module are respectively connected with the driver units, the light emission duration driver module is configured to generate and output a second light emission control signal to each of the driver units, and the second light emission control signal is a pulse signal; and
each of the driver units is configured to control the light emission duration of the light-emitting element connected therewith under an action of the second light emission control signal.

7. The backlight module according to claim 2, wherein,
the controller unit further includes a light emission brightness driver module;
the light emission brightness driver module includes a plurality of output terminals, the plurality of output terminals of the light emission brightness driver module are respectively connected with the driver units, and the light emission brightness driver module is configured to generate and output a second brightness control signal to the driver units connected with the light emission brightness driver module; and
each of the driver units is configured to control the light emission brightness of the light-emitting element connected therewith under an action of the second brightness control signal.

8. The backlight module according to claim 6, further comprising: a control signal terminal, respectively connected with each of the light-emitting elements and the controller unit;
wherein, the controller unit is further configured to output a stop light emission signal to the control signal terminal connected with the controller unit, to control the light-emitting elements connected with the control signal terminal to stop emitting light.

9. The backlight module according to claim 1, further comprising a baseplate, wherein, the light-emitting elements are encapsulated inside the baseplate.

10. The backlight module according to claim 1, wherein, the light-emitting elements are a light emitting diode.

11. The backlight module according to claim 10, wherein, the light-emitting elements are a small light emitting diode or a micro light emitting diode (micro LED).

12. A driving method of a backlight module, the backlight module comprising a plurality of driver units and a plurality of light-emitting elements, wherein,
each of the driver units is connected with one of the light-emitting elements;
the driving method comprises:
independently driving each of the light-emitting elements by one of the driver units, to control at least one of a light emission duration and a light emission brightness of each of the light-emitting elements.

13. The driving method of the backlight module according to claim 12, wherein,
the backlight module further comprises a controller unit respectively connected with the plurality of driver units and a main controller unit connected with the controller unit;
the main controller unit outputs at least one of a light emission control instruction and a brightness control instruction to the controller unit;
the controller unit generates and outputs a control signal to the driver units according to at least one of the light emission control instruction and the brightness control instruction, so that each of the driver units controls at least one of the light emission duration and the light emission brightness of the light-emitting element connected therewith.

14. The driving method of the backlight module according to claim 13, wherein,
the plurality of driver units are arranged in M rows and N columns, where, both M and N are positive integers greater than or equal to 1;
the controller unit generates and outputs a first light emission control signal to the driver units row by row according to the light emission control instruction; the controller unit generates and outputs a first brightness control signal to the driver units connected with the controller unit according to the brightness control instruction;
each of the driver units controls the light-emitting element connected therewith whether to emit light or not, and controls the light emission duration and the light emission brightness of the light-emitting element connected therewith under an action of the first light emission control signal and the first brightness control signal.

15. The driving method of the backlight module according to claim 13, wherein,
the controller unit includes a light emission duration driver module connected with all of the driver units;
the light emission duration driver module generates and outputs a second light emission control signal to each of the driver units according to the light emission control instruction, wherein, the second light emission control signal is a pulse signal;
each of the driver units controls the light emission duration of the light-emitting element connected therewith under an action of the second light emission control signal.

16. The driving method of the backlight module according to claim 13, wherein,
the controller unit includes a light emission brightness driver module connected with all of the driver units;
the light emission brightness driver module generates and outputs a second brightness control signal to each of the driver units connected with the light emission brightness driver module according to the brightness control instruction;
each of the driver units controls the light emission brightness of the light-emitting element connected therewith under an action of the second brightness control signal.

17. The driving method of the backlight module according to claim 15, wherein,
the light-emitting elements are respectively connected with the controller unit through a control signal terminal, and the driving method further comprises:
outputting, by the main controller unit, a stop light emission control instruction, to the controller unit;
generating and outputting, by the controller unit, a stop light emission signal to the control signal terminal connected with the controller unit according to the stop light emission control instruction; and
controlling, by the control signal terminal, the light-emitting elements connected with the control signal terminal to stop emitting light under an action of the stop light emission signal.

18. A display device, comprising the backlight module according to claim 1.
